(19) United States
(12) Patent Application Publication
(10) Pub. No.: US 2025/0103300 A1
(43) Pub. Date: Mar. 27, 2025

(54) SYSTEMS AND METHODS FOR ITERATIVE CODE GENERATION WITH LARGE LANGUAGE MODELS AND REPRESENTATIVE SUB-MODULES

(71) Applicant: Salesforce, Inc., San Francisco, CA (US)

(72) Inventors: Hung Le, Singapore (SG); Hailin Chen, Singapore (SG); Amrita Saha, Singapore (SG); Akash Gokul, San Francisco, CA (US); Doyen Sahoo, Singapore (SG); Shafiq Rayhan Joty, San Jose, CA (US)

(21) Appl. No.: 18/424,372

(22) Filed: Jan. 26, 2024

Related U.S. Application Data
(60) Provisional application No. 63/585,865, filed on Sep. 27, 2023.

(51) Int. Cl. G06F 8/30; G06F 40/40

(52) U.S. Cl. CPC G06F 8/30; G06F 40/40

(57) ABSTRACT

The embodiments are directed to generating source code for a program from a problem description. One or more pre-trained code large language models (LLMs) generate sub-modules from a problem description in a natural language. The sub-modules are filtered based on testing criteria and encoded into sub-module encodings in an embedding space. The sub-module encodings are clustered into multiple clusters. A subset of sub-modules encoding that are close to the centroids of the clusters are selected. The sub-set of sub-modules is decoded into representative sub-modules. The problem description is augmented with the representative sub-modules and fed into one or more pre-trained code LLMs and new sub-modules are generated. The iterations continue until a program is generated from the representative sub-modules.

### CROSS-REFERENCE TO RELATED APPLICATIONS

This application claims priority to U.S. Provisional Application No. 63/585,865, filed Sep. 27, 2023, which is incorporated by reference in its entirety.

### TECHNICAL FIELD

The embodiments relate generally to machine learning systems for generating source code, and more specifically to using large language models to generate sub-modules over multiple iterations that are converted into source code.

### BACKGROUND

Machine learning systems that include large language models (LLMs) have been widely used for solving simple programming tasks, like those in HumanEval or MBPP benchmarks. However, LLM models may not be able to solving more complex and competitive programming tasks because LLM models tend to generate monolithic code blocks instead of decomposing tasks into logical sub-tasks.

Therefore, the embodiments are directed to a code-chain framework that uses an LLM for complex and competitive programming tasks by generating sub-modules representing logical sub-tasks.

### BRIEF DESCRIPTION OF THE DRAWINGS

FIG. 1 is a simplified diagram illustrating a code-chain framework, according to some embodiments.

FIG. 2A is a block diagram illustrating an example problem description, according to some embodiments.

FIG. 2B is a block diagram illustrating example test cases, according to some embodiments.

FIG. 2C is a block diagram illustrating a portion of an example problem description illustrating instructions for a two-step process that generate sub-modules, according to some embodiments.

FIG. 3 is a diagram illustrating an outline of sub-modules and sub-modules, according to some embodiments.

FIG. 4 illustrates a portion of the problem description augmented with representative sub-modules, according to some embodiments.

FIG. 5 is a simplified diagram illustrating a computing device implementing the code chain framework described in FIG. 1, according to some embodiments.

FIG. 6 is a simplified diagram illustrating a neural network structure included in the code chain framework, according to some embodiments.

FIG. 7 is a simplified block diagram of a networked system suitable for implementing the code-chain framework described in FIG. 1 and other embodiments described herein.

FIG. 8 is a flowchart of a method for generating code with a code chain framework, according to some embodiments.

FIGS. 9-10 are tables illustrating results of the code chain framework and other code generation models, according to some embodiments.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

The embodiments are directed to a code chain framework that receives a problem description and generates an executable and functionally correct program. The problem description may be a complex problem described in a natural language and details of expected program behaviors. In some instances, a problem description may include test cases that comprise input and output pairs.

The code chain framework may include one or more large language models or LLMs that may be trained to learn contextual representations from large-scale code data. Once trained, the LLMs may generate source code. The embodiments are directed to using the pre-trained code LLMs to generate sub-modules from a problem description. The sub-modules represent code for complex programming tasks. The code chain framework then selects representative sub-modules by grouping the sub-modules into clusters in the embedding space and selecting a sub-set of clusters that are close centroids of the clusters as determined by a distance algorithm. In some instances, the code chain framework may also filter the sub-modules based on test cases or test data. The problem description may then be augmented with the representative sub-modules. The cycle may continue iteratively over multiple iterations, until the code chain framework generates a program that includes sub-modules which can execute the problem according to the problem description and generate expected results.

Embodiments described herein provide a number of benefits. For example, the embodiments improve code generation using pre-trained LLMs over multiple generations. The embodiments improve accuracy and automatic generation of source code with machine learning based on a problem description.

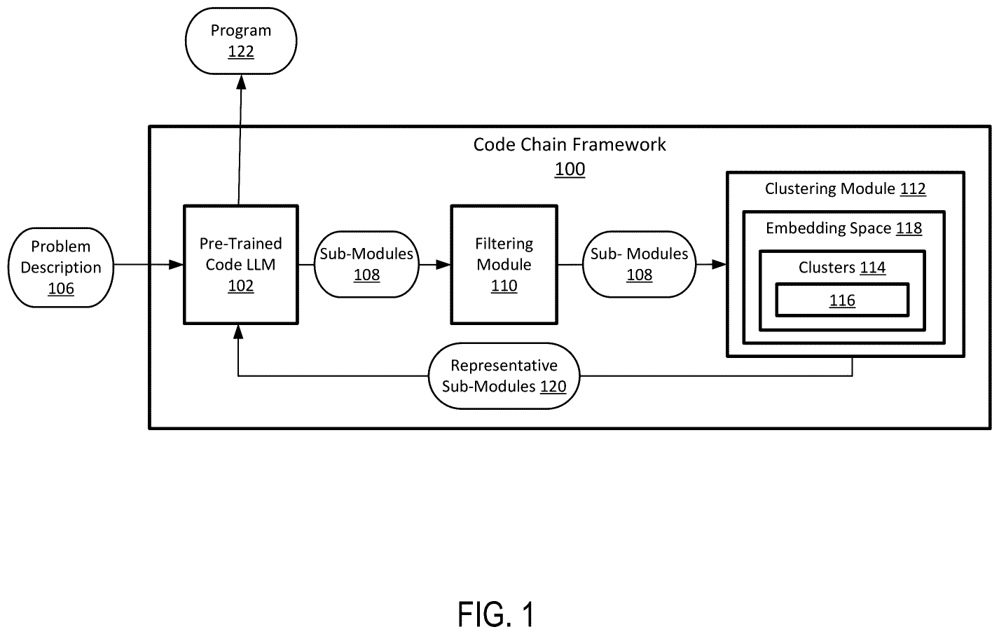

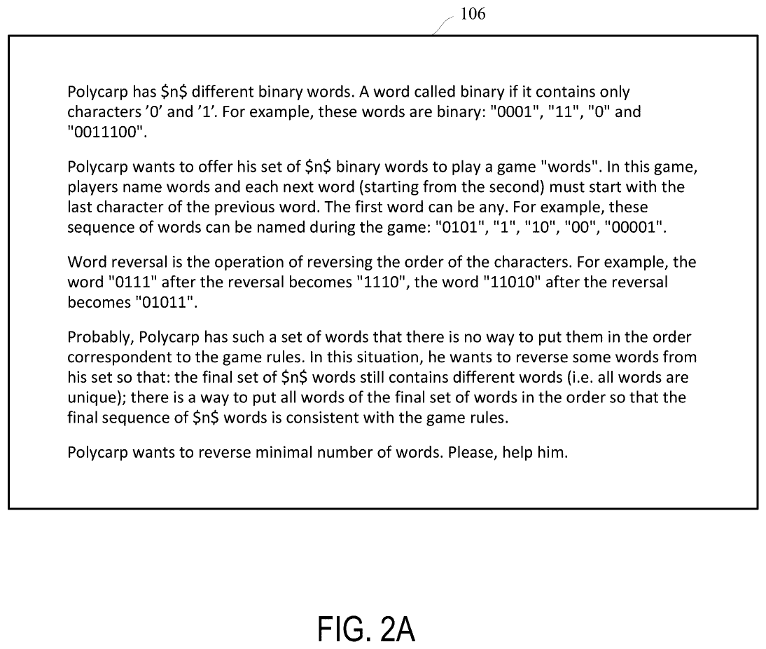

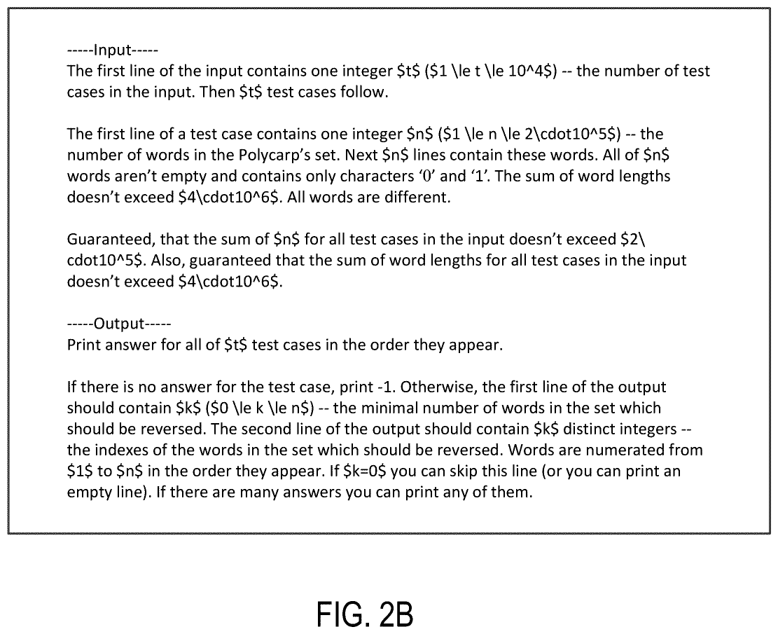

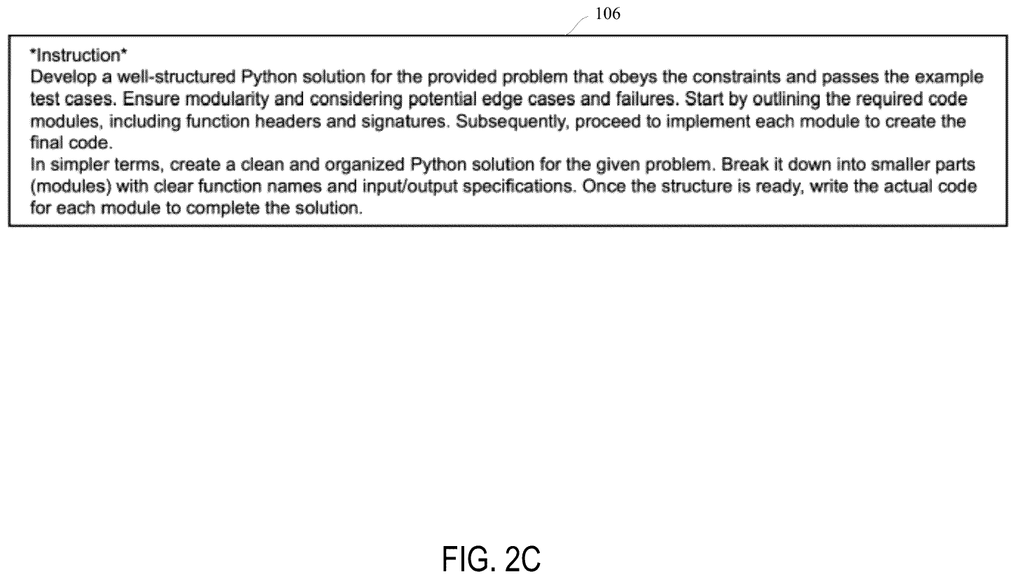

FIG. 1 is a simplified diagram illustrating a code chain framework 100 according to some embodiments. The code chain framework 100 comprises one or more pre-trained code large language models (LLMs) 102, a filtering module 110, and a clustering module 112. The code chain framework 100 receives a problem description 106. Problem description 106 may be a description or a statement for which code chain framework 100 may generate code. Problem description 106 may be a description in a natural language that includes words, numbers, and the like. FIG. 2A is a diagram of a problem description in a natural language, according to some embodiments.

Problem description 106 may also include one or more test cases for testing the code. In some instances, test cases may include pairs comprising input into the program and expected output. FIG. 2B is a diagram of example test cases, according to some embodiments. The example test cases shown in FIG. 2B may be appended to the problem description 106 shown in FIG. 2A.

Code chain framework 100 may use an iterative approach to generate a program. During a first iteration, pre-trained code LLM 102 may receive problem description 106 and autoregressively sample the tokens (or words) in the problem description 106 to generate sub-modules 108. FIG. 2C is a block diagram of a portion of an example problem description, according to some embodiments. The portion of problem description 106 in FIG. 2C may include instructions instructing pre-trained code LLM 102 to generate sub-modules 108 using a two-step process. First, pre-trained code LLM 102 may generate outlines of sub-modules 108. The outlines may include function headers and module descriptions. Function headers may be names of the functions included in sub-modules 108. The module descriptions may describe intended usage or signatures of sub-modules 108. There may be one outline for one sub-module in some embodiments. From the outlines, pre-trained code LLM 102 may generate sub-modules 108 for high-level logical sub-tasks. Sub-modules 108 may include source code that corresponds to the sub-module description in the outline. The portion of problem description 106 may be included with the problem description shown in FIG. 2A.

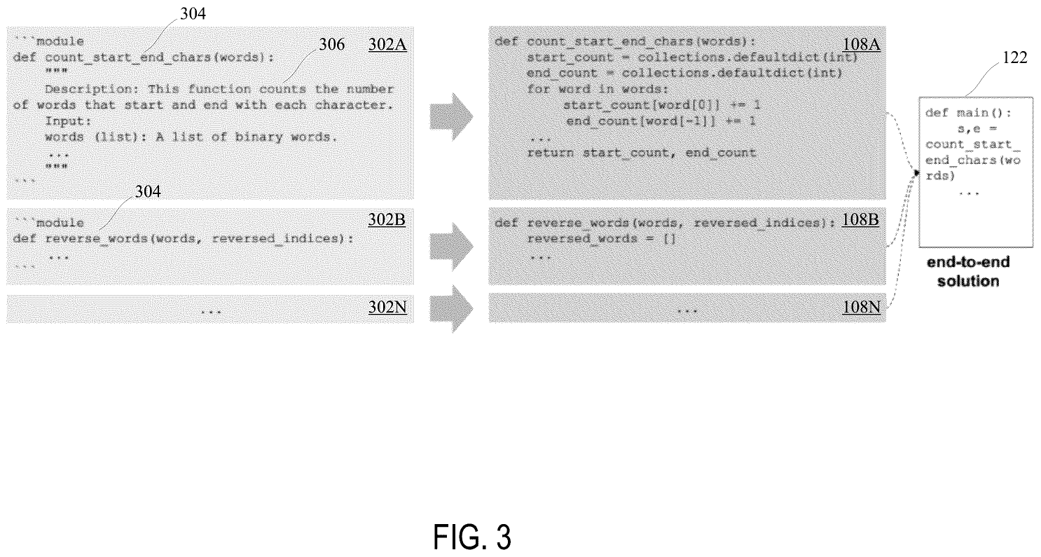

FIG. 3 is a block diagram illustrating outlines for the sub-modules and sub-modules, according to some embodiments. FIG. 3 illustrates outlines 302A-N and corresponding sub-modules 108A-N that are generated from outlines 302A-N. Outlines 302A-N include function headers 304 and module descriptions 306.

Going back to FIG. 1, sub-modules 108 may represent natural boundaries within a program. Example natural boundaries may be portions of the program that perform a particular task, such as functions. Sub-modules 108 may be tested and evaluated using various test cases, including test cases received from the user or included in problem description 106.

In some instances, pre-trained code LLM 102 may generate multiple sub-modules 108 that perform the same function. In this case, code chain framework 100 may include a filtering module 110. The filtering module 110 may filter sub-modules 108 based on various ranking or scoring schemes. Examples schemes may be selecting sub-modules 108 based on execution results from various test cases, execution speed, or a combination thereof. As discussed above, the test cases may be included in problem description 106 or received by sub-modules 108 using a user interface. In some embodiments, pre-trained code LLM 102 may generate thousands of sub-modules 108, and filter module 110 may reduce the thousands of sub-modules 108 to less than one thousand sub-modules 108, or a predefined number of sub-modules. In this case, filtering module 110 may filter sub-modules 108 until a predefined number of sub-modules 108 are remaining.

Clustering module 112 may receive the sub-modules 108 (or filtered sub-modules 108 if filtering module 110 is employed) and generate clusters 114. Clustering module 112 may be pre-trained code LLM 102, or another LLM that is trained or finetuned to generate clusters 114. In some embodiments, clustering module 112 may use a K-means algorithm to group the sub-modules 108 into a predefined number of clusters, such as K number of clusters 114, where K may be an integer. The sub-modules 108 in each cluster 114 may be similar according to one or more criteria as determined by the clustering module 112.

In some embodiments, clustering module 112 may generate sub-module embeddings 116 from sub-modules 108 in an embedding space 118. For example, an LLM may convert sub-modules 108 into sub-module embeddings 116. Clustering module 112 may then group the sub-module embeddings 116 into clusters 114, using a clustering algorithm, such as a K-means algorithm. Next, clustering module 112 may identify one or more sub-module embeddings 116 in each cluster that are closest to (or within a predefined distance from) a centroid of that cluster in clusters 114. The determination may be made using one or more distance algorithms that determine a distance from cluster embeddings 116 to the centroid of the cluster in clusters 114 in the embedding space 118. In some instances, clustering module 112 may select one sub-module embedding from each cluster in clusters 114. Clustering module 112 may then convert the selected sub-module embeddings 116 into representative sub-modules 120. By selecting sub-module embeddings 116 that are closest to a centroid of each cluster, clustering module 112 may select representative sub-modules 120 that are semantically representative and are re-usable across all sub-modules 108.

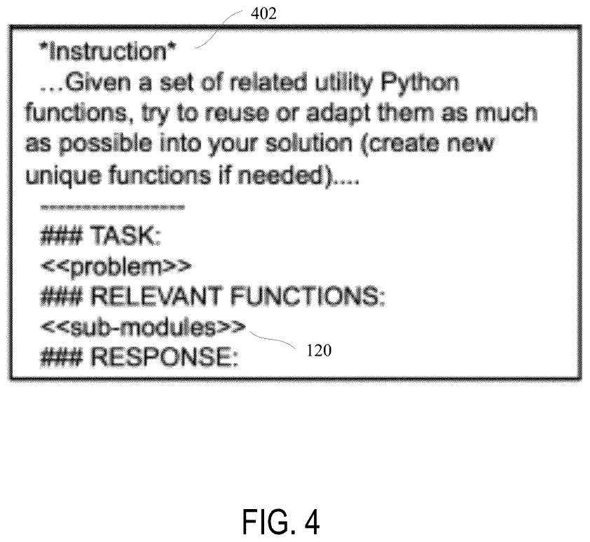

As discussed above, code chain framework 100 may perform multiple iterations before generating a program 122. During the next and subsequent iterations, pre-trained code LLM 102 may receive problem description 106 that is augmented with the representative sub-modules 120 as input. FIG. 4 is a diagram illustrating a portion of the problem description 402 augmented with representative sub-modules 120, according to some embodiments. In another example, the problem description 106 shown in FIG. 2A may be augmented with the test cases shown in FIG. 2B and representative modules 120 (which may be sub-modules 108A and 108B shown in FIG. 3). Code chain framework 100 then repeats the process described above for the next and subsequent iterations, by generating sub-modules 108, clusters 114, and representative sub-modules 120. The iterative approach may occur over configurable number of iterations, such as N iterations, until on the final iteration representative sub-modules 120 are determined. These representative sub-modules 120 may be linked in sequence into a source code that may execute as program 122 for problem description 106. An example program 122 is shown in FIG. 3.

In some embodiments, problem description 106 may be referred to as input sequence D, and program 122 may be an output sequence designated as Ŵ=( [symbol] , . . . , [symbol] ) with tokens ŵₜ∈V. The pre-trained code LLM 102 (also referred to as θ) may generate a code sequence by autoregressively sampling tokens ŵₜ from the parameterized conditional distribution p_{θ}(.|ŵ_{1:t-1}, D). The test cases that test sub-modules 108 or program 122 may be input-output pairs {(iⱼ, 0ⱼ)}ⱼ₌₁^{J}. An output of program 122 (also referred to as Ŵ) may be correct when Ŵ(iⱼ)=oⱼ for all j∈{1, . . . , J}. If the problem description 106 includes some test cases, those test cases may be designated as {(iₘ′, oₘ′)}ₘ₌₁^{M} where M<<J.

In some embodiments, the output of pre-trained code LLM 102 may be defined as Ŝᵢ˜p_{θ}(.|Ŝ_{1:i-1}, D) for sub-modules 108, including headers and module descriptions, and as ŵᵢ˜p_{θ}(.|_{1:i-1},{Ŝᵢ}, D) for tokens in the final solution.

In some embodiments, pre-trained code LLM 102 may generate a pre-defined number of sub-modules 108 over multiple iterations. The predefined number of sub-modules 108 may be M, where M is an integer. In this embodiment, Ŝ may be all sub-modules 108 and Ŝ={{Ŝᵢ}ₙ} may represent the pre-defined number N of sub-module 108, where {Ŝᵢ}ₙ are the set of sub-modules in the n—the generated sample.

As discussed above, clustering module 112 may determine representative sub-modules 120 as sub-modules 108 that are closest to the centroid of each cluster in clusters 114 in the embedding space 118. Representative sub-modules 120 may be determined as

$${\hat{C}}_{k} = arg {min}_{{\hat{S}}^{k}} ‖ {S}_{i}^{k} - {u}_{k} ‖ ,$$

where Sᵢ^{k} is an embedded representation of sub-module Ŝᵢ in cluster k, and uₖ is the centroid of cluster k.

In some embodiments, during the revision round R, e.g., during the iteration R, the output token of pre-trained code LLM 102 may be sampled from the conditional distribution that is ŵₜ^{R}˜p_{θ}(.|ŵ_{1:t-1}^{R}, {Ŝᵢ^{R}}, Ĉ^{R-1}, D), where Ĉ^{R-1}={Ĉₖ^{R-1}}ₖ₌₁^{K} is the set of representative sub-modules 120 from the previous iteration R−1, and D is the problem statement 106. During the iteration R, the new sub-modules 108 may be generated by the conditional probability that is Ŝᵢ^{R}˜p^{θ}(.|Ŝ_{1:i-1}^{R}, Ĉ^{R-1}, D).

### Computer and Network Environment

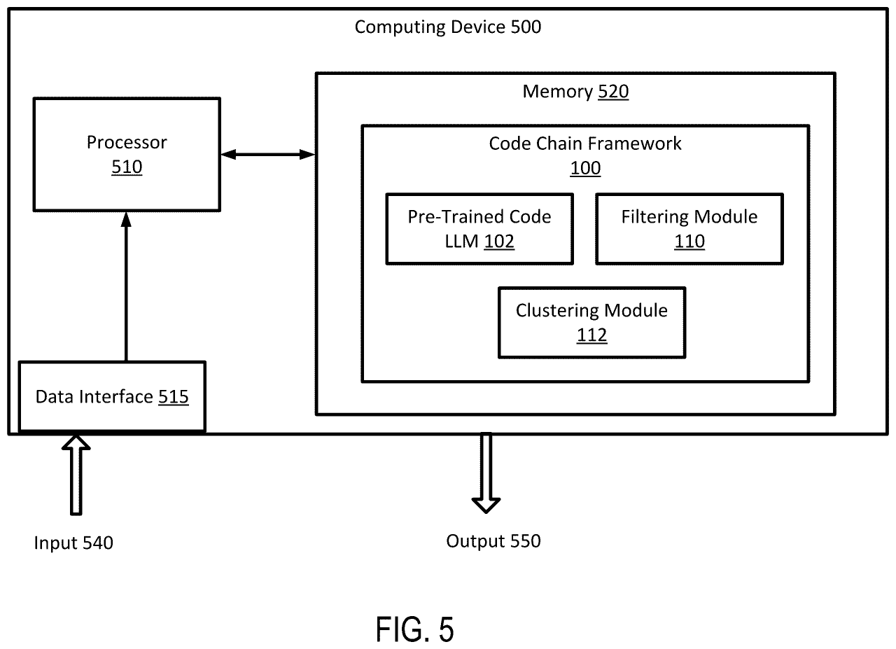

FIG. 5 is a simplified diagram illustrating a computing device implementing the code chain framework 100 described in FIG. 5, according to one embodiment described herein. As shown in FIG. 5, computing device 500 includes a processor 510 coupled to memory 520. Operation of computing device 500 is controlled by processor 510. And although computing device 500 is shown with only one processor 510, it is understood that processor 510 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 500. Computing device 500 may be implemented as a stand-alone subsystem, as a board added to a computing device, and/or as a virtual machine.

Memory 520 may be used to store software executed by computing device 500 and/or one or more data structures used during operation of computing device 500. Memory 520 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 510 and/or memory 520 may be arranged in any suitable physical arrangement. In some embodiments, processor 510 and/or memory 520 may be implemented on a same board, in a same package (e.g., system-in-package), on a same chip (e.g., system-on-chip), and/or the like. In some embodiments, processor 510 and/or memory 520 may include distributed, virtualized, and/or containerized computing resources. Consistent with such embodiments, processor 510 and/or memory 520 may be located in one or more data centers and/or cloud computing facilities.

In some examples, memory 520 may include non-transitory, tangible, machine readable media that includes executable code that when run by one or more processors (e.g., processor 510) may cause the one or more processors to perform the methods described in further detail herein. For example, as shown, memory 520 includes instructions for 530 that may be used to implement and/or emulate the systems and models, and/or to implement any of the methods described further herein. Code chain framework 100 may receive input 540 such as problem description 106 via the data interface 515 and generate an output 550 which may be modules that include executable code based on the problem description 106.

The data interface 515 may comprise a communication interface, a user interface (such as a voice input interface, a graphical user interface, and/or the like). For example, the computing device 500 may receive the input 540 (such as problem description 106) from a networked database via a communication interface. Or the computing device 500 may receive the input 540 from a user via the user interface.

Some examples of computing devices, such as computing device 500 may include non-transitory, tangible, machine readable media that include executable code that when run by one or more processors (e.g., processor 510) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

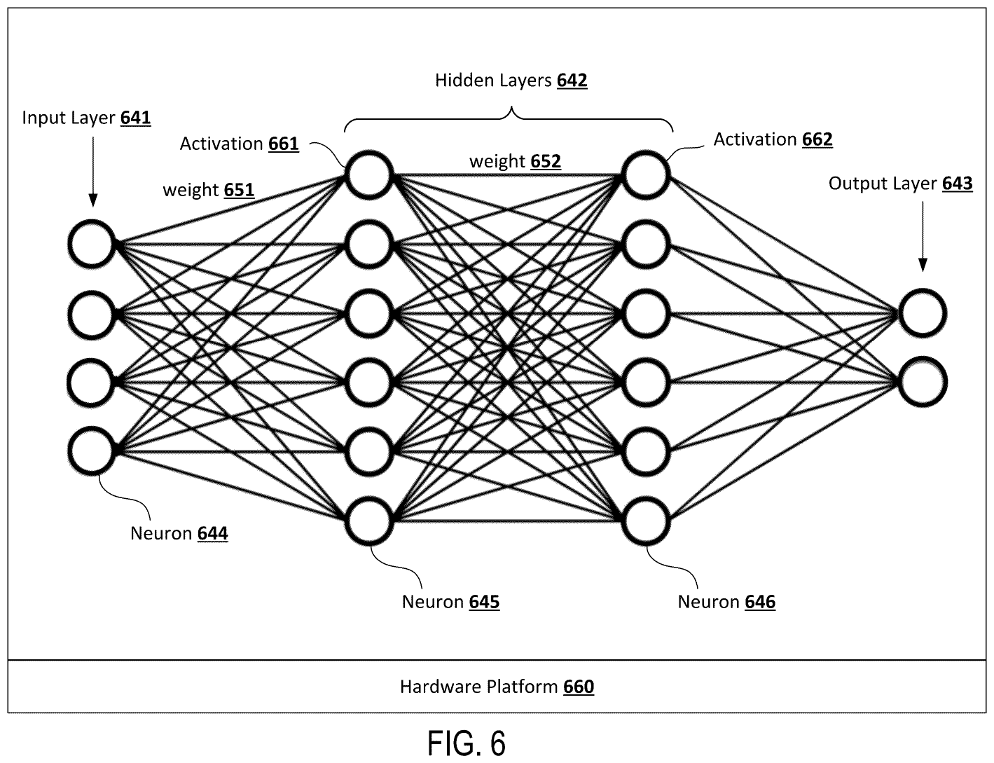

FIG. 6 is a simplified diagram illustrating the neural network structure implementing some components of code chain framework 100 described in FIGS. 1 and 5 according to some embodiments. In some embodiments, the code chain framework 100 and/or one or more of its components, including at least the pre-trained code LLM 102 may be implemented at least partially via an artificial neural network structure shown in FIG. 6. The neural network comprises a computing system that is built on a collection of connected units or nodes, referred to as neurons (e.g., 644, 645, 646). Neurons are often connected by edges, and an adjustable weight (e.g., 651, 652) is often associated with the edge. The neurons are often aggregated into layers such that different layers may perform different transformations on the respective input and output transformed input data onto the next layer.

For example, the neural network architecture may comprise an input layer 641, one or more hidden layers 642 and an output layer 646. Each layer may comprise a plurality of neurons, and neurons between layers are interconnected according to a specific topology of the neural network topology. The input layer 641 receives the input data such as problem description 106 in a natural language for which a code solution may be generated. The number of nodes (neurons) in the input layer 641 may be determined by the dimensionality of the input data (e.g., the length of a vector for the problem description 106). Each node in the input layer represents a feature or attribute of the input.

The hidden layers 642 are intermediate layers between the input and output layers of a neural network. It is noted that two hidden layers 642 are shown in FIG. 6 for illustrative purpose only, and any number of hidden layers may be utilized in a neural network structure. Hidden layers 642 may extract and transform the input data through a series of weighted computations and activation functions.

For example, as discussed in FIG. 5, the code chain framework 100 receives an input 540 of a problem description in a natural language and transforms the input into an output 550 of code segments. To perform the transformation, each neuron receives input signals, performs a weighted sum of the inputs according to weights assigned to each connection (e.g., 651, 652), and then applies an activation function (e.g., 661, 662, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 641 is transformed into rather different values indicative data characteristics corresponding to a task that the neural network structure has been designed to perform.

The output layer 643 is the final layer of the neural network structure. It produces the network's output or prediction based on the computations performed in the preceding layers (e.g., 641, 642). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the code chain framework 100 and/or one or more of its components may comprise the transformative neural network structure of layers of neurons, and weights and activation functions describing the non-linear transformation at each neuron. Such a neural network structure is often implemented on one or more hardware processors 610, such as a graphics processing unit (GPU). An example neural network may be a feed forward neural network, deep neural network, recurrent neural network, convolutional neural network, long-short-term memory neural network, a combination of one or more neural networks, and/or the like.

In one embodiment, the code chain framework 100 and one or more of its components may be implemented by hardware, software and/or a combination thereof. For example, the code chain framework 100 and one or more of its components may comprise a specific neural network structure implemented and run on various hardware platforms 660, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 660 used to implement the neural network structure is specifically configured based on factors such as the complexity of the neural network, the scale of the tasks (e.g., training time, input data scale, size of training dataset, etc.), and the desired performance.

In one embodiment, the neural network based code chain framework 100 and/or its components may be trained by iteratively updating the underlying parameters (e.g., weights 651, 652, etc., bias parameters and/or coefficients in the activation functions 661, 662 associated with neurons) of the neural network based on the loss. For example, during forward propagation, the training data such as code sections and problem descriptions are fed into the neural network. The data flows through the network's layers 641, 642, with each layer performing computations based on its weights, biases, and activation functions until the output layer 643 produces the network's output 650. In some embodiments, output layer 643 produces an intermediate output on which the network's output 650 is based.

The output generated by the output layer 643 is compared to the expected output (e.g., a “ground-truth”) from the training data, to compute a loss function that measures the discrepancy between the predicted output and the expected output. Given the loss, the negative gradient of the loss function is computed with respect to each weight of each layer individually. Such negative gradient is computed one layer at a time, iteratively backward from the output layer 643 to the input layer 641 of the neural network. These gradients quantify the sensitivity of the network's output to changes in the parameters. The chain rule of calculus is applied to efficiently calculate these gradients by propagating the gradients backward from the output layer 643 to the input layer 641.

Parameters of the neural network are updated backwardly from the last layer to the input layer (backpropagating) based on the computed negative gradient using an optimization algorithm to minimize the loss. The backpropagation from the output layer 643 to the input layer 641 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions, such as code sections on new, unseen data, such as problem descriptions.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

Therefore, the training process transforms the neural network into an “updated” trained neural network with updated parameters such as weights, activation functions, and biases. The trained neural network thus improves neural network technology for generating code sections from a problem statement.

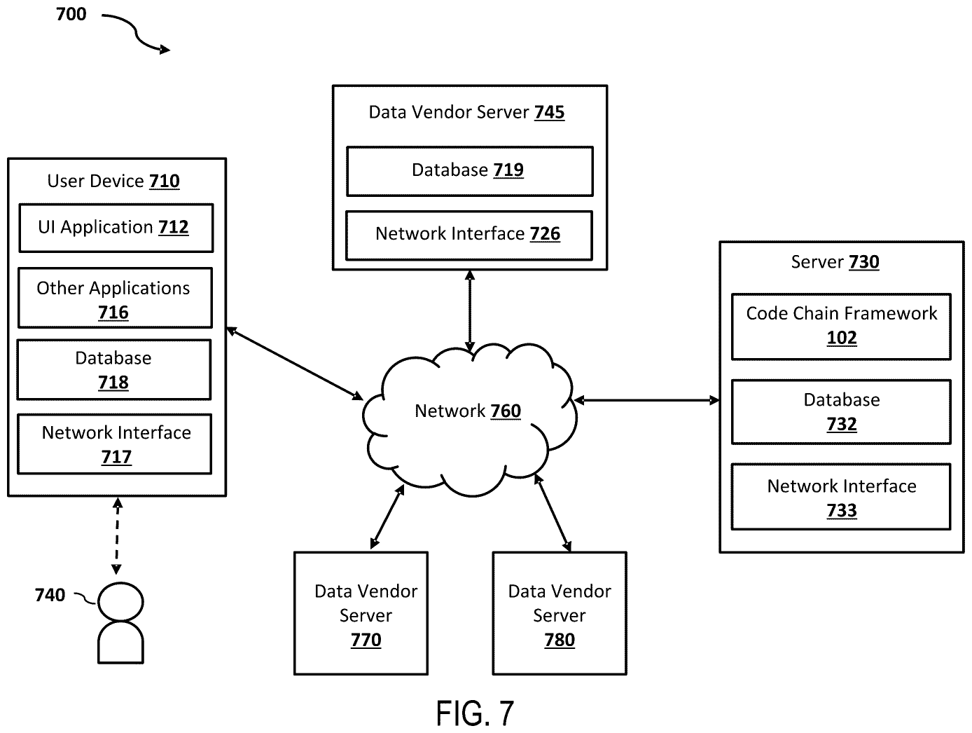

FIG. 7 is a simplified block diagram of a networked system 700 suitable for implementing the code chain framework 100 described in FIGS. 1-6 and other embodiments described herein. In one embodiment, system 700 includes the user device 710 which may be operated by user 740, data vendor servers 745, 770 and 780, server 730, and other forms of devices, servers, and/or software components that operate to perform various methodologies in accordance with the described embodiments. Exemplary devices and servers may include device, stand-alone, and enterprise-class servers which may be similar to the computing device 500 described in FIG. 5, operating an OS such as a MICROSOFT® OS, a UNIX® OS, a LINUX® OS, or other suitable device and/or server-based OS. It can be appreciated that the devices and/or servers illustrated in FIG. 7 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 710, data vendor servers 745, 770 and 780, and the server 730 may communicate with each other over a network 760. User device 710 may be utilized by a user 740 (e.g., a driver, a system admin, etc.) to access the various features available for user device 710, which may include processes and/or applications associated with the server 730 to receive an output data anomaly report.

User device 710, data vendor server 745, and the server 730 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 700, and/or accessible over network 760.

User device 710 may be implemented as a communication device that may utilize appropriate hardware and software configured for wired and/or wireless communication with data vendor server 745 and/or the server 730. For example, in one embodiment, user device 710 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 710 of FIG. 7 contains a user interface (UI) application 712, and/or other applications 716, which may correspond to executable processes, procedures, and/or applications with associated hardware. For example, the user device 710 may receive a message from the server 730 and display the message via the UI application 712. In other embodiments, user device 710 may include additional or different modules having specialized hardware and/or software as required.

In various embodiments, user device 710 includes other applications 716 as may be desired in particular embodiments to provide features to user device 710. For example, other applications 716 may include security applications for implementing client-side security features, programmatic client applications for interfacing with appropriate application programming interfaces (APIs) over network 760, or other types of applications. Other applications 716 may also include communication applications, such as email, texting, voice, social networking, and 1M applications that allow a user to send and receive emails, calls, texts, and other notifications through network 760. For example, the other application 716 may be an email or instant messaging application that receives a prediction result message from the server 730. Other applications 716 may include device interfaces and other display modules that may receive input and/or output information. For example, other applications 716 may contain software programs, executable by a processor, including a graphical user interface (GUI) configured to provide an interface to the user 740 to view a problem description statement or test cases to test the code.

User device 710 may further include database 718 stored in a transitory and/or non-transitory memory of user device 710, which may store various applications and data and be utilized during execution of various modules of user device 710. Database 718 may store user profile relating to the user 740, predictions previously viewed or saved by the user 740, historical data received from the server 730, and/or the like. In some embodiments, database 718 may be local to user device 710. However, in other embodiments, database 718 may be external to user device 710 and accessible by user device 710, including cloud storage systems and/or databases that are accessible over network 760.

User device 710 includes at least one network interface component 717 adapted to communicate with data vendor server 745 and/or the server 730. In various embodiments, network interface component 717 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 745 may correspond to a server that hosts database 719 to provide training datasets including sample source code, problem statements, and the like to the server 730. The database 719 may be implemented by one or more relational database, distributed databases, cloud databases, and/or the like.

The data vendor server 745 includes at least one network interface component 726 adapted to communicate with user device 710 and/or the server 730. In various embodiments, network interface component 726 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 745 may send asset information from the database 719, via the network interface 726, to the server 730.

The server 730 may be housed with the code chain framework 100 and its components described in FIGS. 1-6. In some implementations, code chain framework 100 may receive data from database 719 at the data vendor server 745 via the network 760 to generate code. The generated code may also be sent to the user device 710 for review, execution, and testing by the user 740 via the network 760.

The database 732 may be stored in a transitory and/or non-transitory memory of the server 730. In one implementation, the database 732 may store data obtained from the data vendor server 745. In one implementation, the database 732 may store parameters and embeddings of the code chain framework 100. Database 732 may also store previously generated problem description 106 and the corresponding input feature vectors.

In some embodiments, database 732 may be local to the server 730. However, in other embodiments, database 732 may be external to the server 730 and accessible by the server 730, including cloud storage systems and/or databases that are accessible over network 760.

The server 730 includes at least one network interface component 733 adapted to communicate with user device 710 and/or data vendor servers 745, 770 or 780 over network 760. In various embodiments, network interface component 733 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 760 may be implemented as a single network or a combination of multiple networks. For example, in various embodiments, network 760 may include the Internet or one or more intranets, landline networks, wireless networks, and/or other appropriate types of networks. Thus, network 760 may correspond to small scale communication networks, such as a private or local area network, or a larger scale network, such as a wide area network or the Internet, accessible by the various components of system 700.

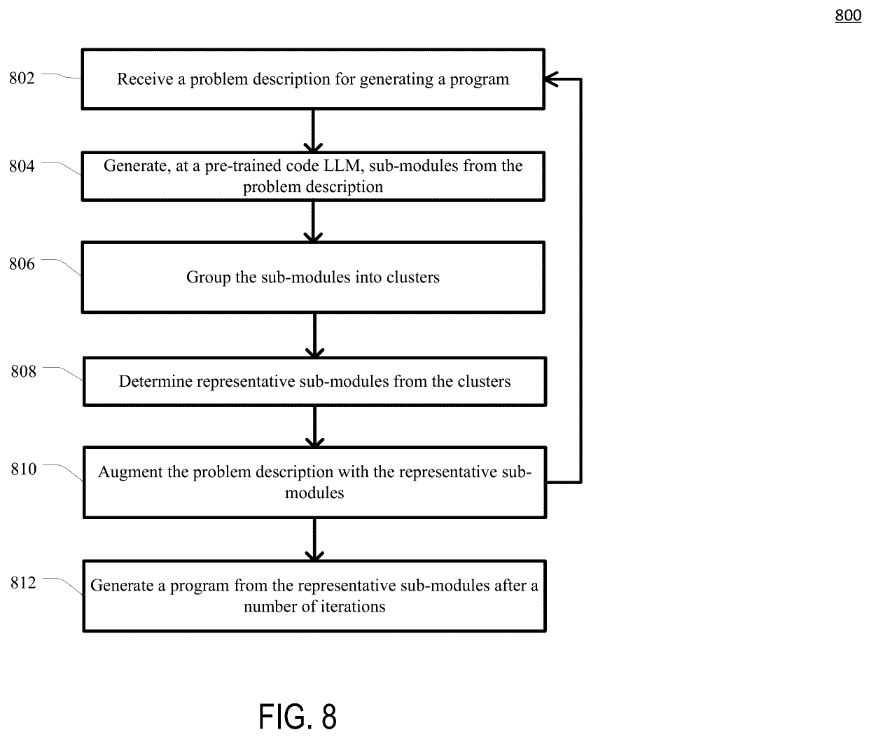

FIG. 8 is a simplified diagram of a method 800 for using a code chain framework to generate code from a problem description, according to some embodiments. One or more of the processes 802-810 of method 800 may be implemented, at least in part, in the form of executable code stored on non-transitory, tangible, machine-readable media that when run by one or more processors may cause the one or more processors to perform one or more of the processes 802-810. Processes 802-810 may repeat over multiple iterations, until representative sub-modules 120 that may be combined into program 308 are generated.

At operation 802, problem description 106 is received at a code chain framework 100. As discussed above, problem description 106 may be in a natural language and may also include test cases as input/output pairs. An example problem description is shown in FIG. 2.

At operation 804, pre-trained code LLM 102 generates sub-modules 108 from the problem description 106. For example, pre-trained code LLM 102 may generate sub-modules 108 from problem description 106 in a two-step process, including generating outlines of sub-modules 108 that include function headers and module descriptions, and then generating the source code that is included in sub-modules 108.

At operation 806, clustering module 112 generates clusters 114 from the sub-modules 108. In some instances, sub-modules 108 may be converted to sub-module embeddings 116 in embedding space 118. The clusters 114 may be generated using a K-means algorithm by grouping sub-module embeddings 116 into clusters 114. In some instances, prior to operation 806, sub-modules 108 may be filtered into a subset of sub-modules 108 based on test cases or other criteria.

At operation 808, clustering module 112 may determine representative sub-modules 120. For example, clustering module 112 may determine one sub-module embeddings in each cluster in clusters 114 that is closest to a centroid of the cluster. The determination may be made using one or more distance algorithms that measure the distance between the centroid of one of clusters 114 and sub-module embeddings 116 in the cluster. From the determined sub-module embeddings 108, clustering module 112 may generate representative sub-modules 120.

At operation 810, problem description 106 may be augmented with representative sub-modules 120 and fed into pre-trained code LLM 102 during a subsequent iteration. To start the subsequent iteration, method 800 proceeds to operation 802. The iterations may continue for a predefined number of iteration.

At operation 812, a program is generated. For example, program 122 may be generated by linking the source code in representative sub-modules 120. Program 122 may be an executable program that may execute to generate an answer to problem description 106.

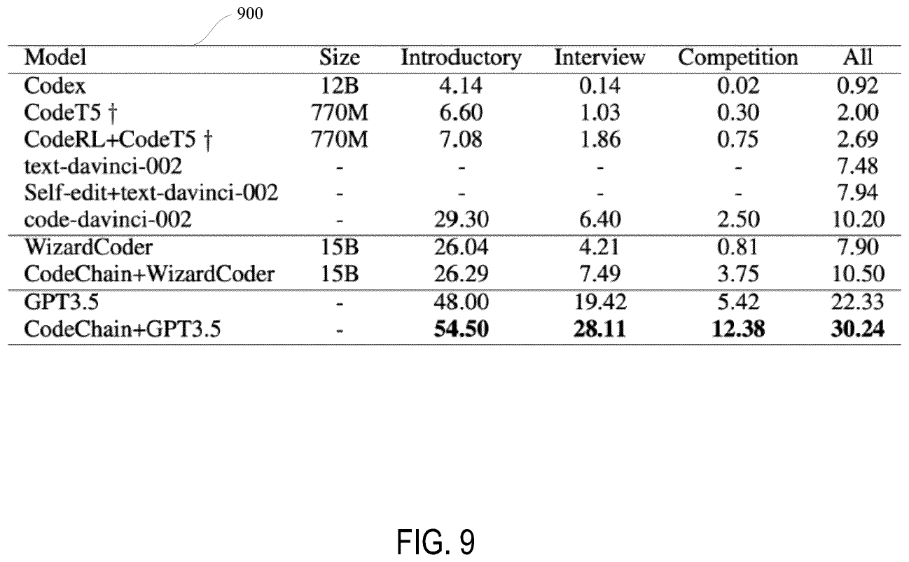

FIG. 9 illustrates a table 900 with results of experiments between source code generated by a code chain framework with the source code generated by other models, according to some embodiments. As illustrated in table 900, source code generated using code chain framework 100 that uses pre-trained code LLM 102 outperforms the source code generated by other frameworks that include pre-trained code LLM 102. Additionally, table 900 illustrates that code chain framework 100 improves the performance of pre-trained code LLM 102, including GPT 3.5 and WizardCoder when generating source code. Accordingly, using an iterative approach to generate source code and appending the generated source code in sub-modules 108 to the problem description 106 improves the accuracy and reduced errors in the resulting program 122.

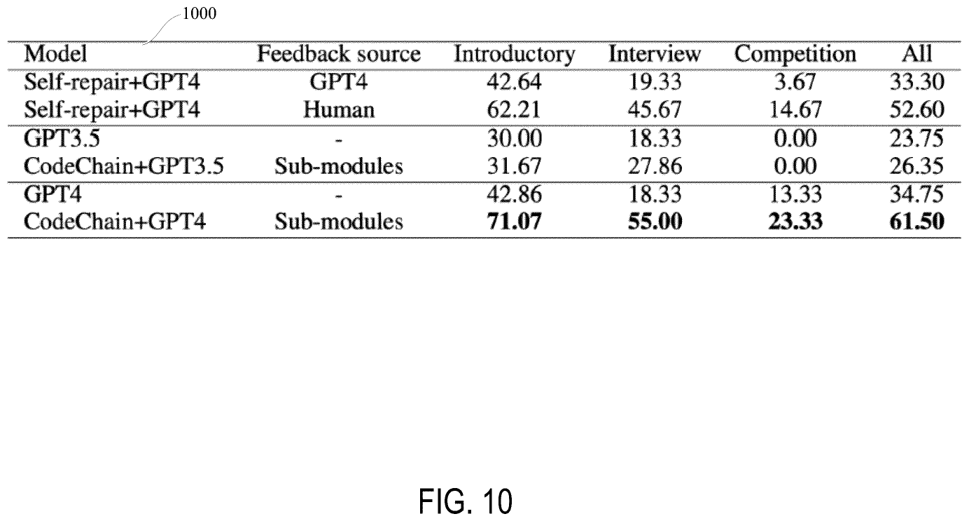

FIG. 10 illustrates a table 1000 with results of experiments illustrating that code chain framework improves accuracy of the source code generated by the pre-trained code LLMs 102, including GPT 3.5 and GPT 4.0, as opposed to pre-trained code LLMs that do not use the code chain framework. As illustrated in FIG. 10, the source code generated using the code chain framework outperforms the source code generated using pre-trained LLMs 102 that also received user feedback as part of the input.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method comprising:
generating, using one or more pre-trained large language models (LLMs), a plurality of sub-modules from a problem description in a natural language;
grouping the plurality of sub-modules into a plurality of clusters;
selecting representative sub-modules from the plurality of clusters;
augmenting the problem description with the representative sub-modules;
generating new sub-modules from the augmented problem description; and
generating source code for the problem description from the new sub-modules.

2. The method of claim 1, wherein the grouping further comprises:
encoding, using the one or more pre-trained LLMs, the plurality of sub-modules into sub-module encodings in an embedding space; and
clustering the sub-module encodings into the plurality of clusters.

3. The method of claim 2, wherein the selecting further comprises:
determining centroids in the plurality of clusters; and
selecting a subset of sub-module encodings that are closest to the centroids.

4. The method of claim 3, further comprising:
converting the subset of sub-module encodings into the representative sub-modules.

5. The method of claim 1, further comprising:
generating new representative sub-modules from the new sub-modules;
generating the source code from the new representative sub-modules; and
generating a program from the source code.

6. The method of claim 5, further comprising:
executing the program to generate a solution for the problem description.

7. The method of claim 1, wherein generating the plurality of sub-modules further comprises:
generating outlines describing the plurality of sub-modules; and
generating source code from the outlines to be included in the plurality of sub-modules.

8. The method of claim 7, wherein an outline in the outlines includes a function header and a description statement.

9. A system comprising:
a memory configured to store one or more pre-trained large language models (LLMs); and
a processor coupled to the memory and configured to perform operations, the operations comprising:
receiving a problem description in a natural language;
generating, using one or more pre-trained LLMs, a plurality of sub-modules from the problem description;
encoding, using the one or more pre-trained LLMs, the plurality of sub-modules into sub-module encodings in an embedding space;
clustering the sub-module encodings into a plurality of clusters;
selecting a subset of sub-module encodings from the plurality of clusters;
generating representative sub-modules from the subset of sub-module encodings; and
generating, using the one or more pre-trained LLMs, the problem description and the representative sub-modules, new sub-modules.

10. The system of claim 9, wherein the operations for selecting the subset of the sub-module encodings further comprise operations:
selecting sub-module encodings into the subset of sub-module encodings that are with a predefined distance to centroids of the plurality of clusters in the embedding space.

11. The system of claim 9, wherein the operations for selecting the subset of the sub-module encodings further comprise operations:
selecting one sub-module encoding from one cluster in the plurality of clusters into the subset of sub-module encodings, wherein the one sub-module encoding has a closest distance to a centroid of the one cluster.

12. The system of claim 9, wherein the operations further comprise:
selecting a pre-defined number of sub-modules from the plurality of sub-modules; and
wherein the encoding further comprises, encoding the pre-defined number of sub-modules into the sub-module encodings.

13. The system of claim 9, wherein the operations further comprise:
combining the representative sub-modules into source code.

14. The system of claim 13, wherein the operations further comprise:
executing the source code to generate a solution to the problem description.

15. The system of claim 9, wherein to generate the plurality of sub-modules, the operations further comprise:
generating outlines describing the plurality of sub-modules; and
generating source code from the outlines to be included in the plurality of sub-modules.

16. The system of claim 15, wherein an outline in the outlines includes a function header and a description statement.

17. A non-transitory computer readable medium storing instructions thereon, that when executed by a processor, cause the processor to perform operations, the operations comprising:
receiving a problem description in a natural language;
generating, using one or more pre-trained large language models (LLMs), a plurality of sub-modules from the problem description;
grouping the plurality of sub-modules into a plurality of clusters;
selecting representative sub-modules from the plurality of clusters;
augmenting the problem description with the representative sub-modules; and
generating, using the one or more pre-trained LLMs, new sub-modules from the augmented problem description.

18. The non-transitory computer readable medium of claim 17, further comprising:
encoding, using the one or more pre-trained LLMs, the plurality of sub-modules into sub-module encodings in an embedding space; and
clustering the sub-module encodings into the plurality of clusters.

19. The non-transitory computer readable medium of claim 17, further comprising:
generating source code from the new sub-modules.

20. The non-transitory computer readable medium of claim 18, further comprising:
selecting sub-module encodings from the plurality of clusters, one sub-module encoding from one cluster in the plurality of clusters.
